(19) United States
(12) Patent Application Publication
(10) Pub. No.: US 2008/0134082 A1
(43) Pub. Date: Jun. 5, 2008

(54) APPARATUS AND METHOD OF DISPLAYING THE STATUS OF A COMPUTING TASK

(75) Inventors: Marc Dominique Delacroix, Maurepas (FR); Camel Aissani, Livry-Gargan (FR); Ludovic Engrand, Torcy (FR); Arnaud Nouard, Franconville (FR)

Correspondence Address: COOLEY GODWARD KRONISH LLP;ATTN: Patent Group, Suite 1100, 777 - 6th Street, NW, Washington, DC, 20001, US

(73) Assignee: BUSINESS OBJECTS, S.A., Levallois-Perret (FR)

(21) Appl. No.: 11/566,668

(22) Filed: Dec. 4, 2006

(51) Int. Cl. G06F 3/048

(52) U.S. Cl. 715/790

(57) ABSTRACT

A computer implemented method includes displaying a window with a first section characterizing a computing task and a second section with a progress bar and an interaction button. An overlay pane is displayed with a status message and an animation indicating that the computing task is active. The overlay pane covers at least a portion of the first section and is partially transparent such that a covered portion of the first section is visible through the overlay pane.

### BRIEF DESCRIPTION OF THE INVENTION

This invention relates generally to digital data processing. More particularly, this invention relates to an interface for displaying the status of computing tasks.

### BACKGROUND OF THE INVENTION

Effectively displaying information to relate the progress of a computing task to a user is an important aspect of modern graphical user interface (GUI) systems. The prior art has approached the display of computing task progress by providing multiple separate, and often confusingly overlapping windows, each displaying an aspect of progress information, or a single window displaying only one aspect of progress information at a time. It would be desirable to provide improved techniques for displaying the status of computing tasks in a window of a graphical user interface. More particularly, it would be desirable to provide improved techniques and systems for displaying multiple aspects of information relating to the status and progress of computing tasks in a single window of a GUI, while also providing for interaction with and/or control over the computing task.

### SUMMARY OF INVENTION

The invention includes a computer implemented method for displaying a window with a first section characterizing a computing task and a second section with a progress bar and an interaction button. An overlay pane is displayed with a status message and an animation indicating that the computing task is active. The overlay pane covers at least a portion of the first section and is partially transparent such that a covered portion of the first section is visible through the overlay pane.

The invention also includes a computer readable storage medium storing executable instructions to display the status of a computing task. The executable instructions display a window with a first section characterizing a computing task and a second section with a progress bar and an interaction button. The executable instructions also display an overlay pane with a status message and an animation indicating that the computing task is active. The overlay pane covers at least a portion of the first section and is partially transparent such that a covered portion of the first section is visible through the overlay pane.

### BRIEF DESCRIPTION OF THE FIGURES

The invention is more fully appreciated in connection with the following detailed description taken in conjunction with the accompanying drawings, in which:

FIG. 1 illustrates a computer constructed in accordance with an embodiment of the invention.

FIG. 2 illustrates a series of processing operations associated with an embodiment of the invention.

FIG. 3 illustrates a window with a first section for initiating a computing task, in accordance with an embodiment of the invention.

FIG. 4 illustrates a window with first and second sections and an overlay pane, displaying the progress of a computing task, in accordance with an embodiment of the invention

FIG. 5 illustrates a window displaying the status of a completed computing task, in accordance with an embodiment of the invention

Like reference numerals refer to corresponding parts throughout the several views of the figures.

### DETAILED DESCRIPTION OF THE INVENTION

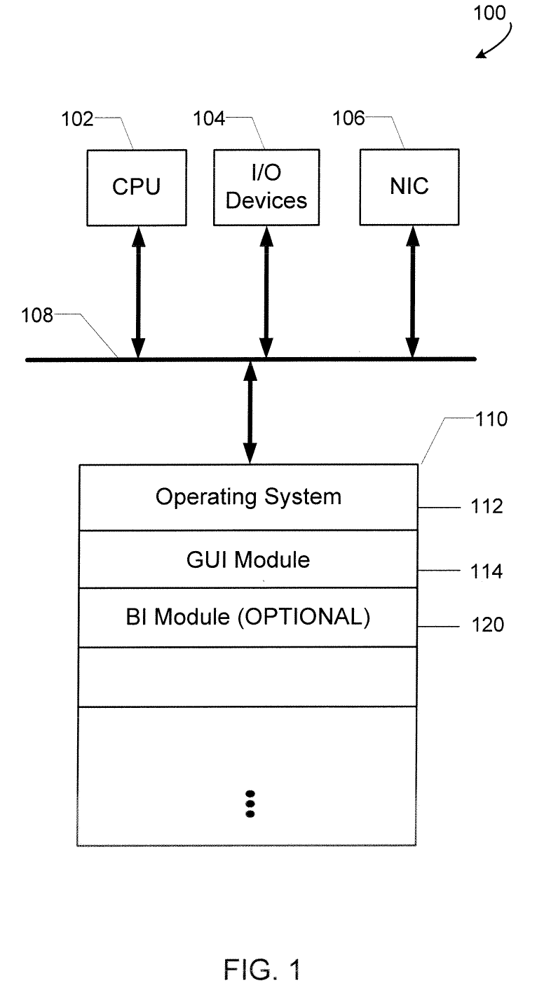

FIG. 1 illustrates a computer 100 constructed in accordance with an embodiment of the invention. The computer 100 includes standard components, including a central processing unit 102 and input/output devices 104, which are linked by a bus 108. The input/output devices 104 may include a keyboard, mouse, touch screen, monitor, printer, and the like. A network interface circuit (NIC) 106 is also connected to the bus 108. The network interface circuit 106 provides connectivity to a network (not shown), thereby allowing the computer 100 to operate in a networked environment.

A memory 10 is also connected to computer 100 through the bus 108. The memory 110 stores executable instructions to implement operations of the invention. In one embodiment, the memory 110 stores one or more of the following modules: an operating system module 112, a Graphical User Interface (GUI) module 114, and optionally, a Business Intelligence (BI) module 120.

The operating system module 112 may include instructions for handling various system services, such as file services or for performing hardware dependant tasks. The GUI module 114 may rely upon standard techniques to produce graphical components of a user interface, e.g., windows, icons, buttons, menus and the like for display on an output device 104, examples of which are discussed below. The user interface may include instructions to receive input from a pointer device and display a cursor on an output device. In one embodiment, the GUI module 114 includes executable instructions to display a window characterizing a computing task, accept an input to initiate the computing task, display progress information for the computing task, and display an overlay pane with a status message related to the computing task in the window.

The optional BI module 120 may comprise executable instructions to perform Business Intelligence (BI) related tasks, such as, generate, view or share reports, perform queries and analyses, and the like. In one embodiment of the invention, the BI module 120 includes executable instructions to import or export BI data or documents, including providing progress information relating to the importing or exporting of BI data or documents to the GUI module 114 for display in a window on an output device 104.

The executable modules stored in memory 110 are exemplary. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

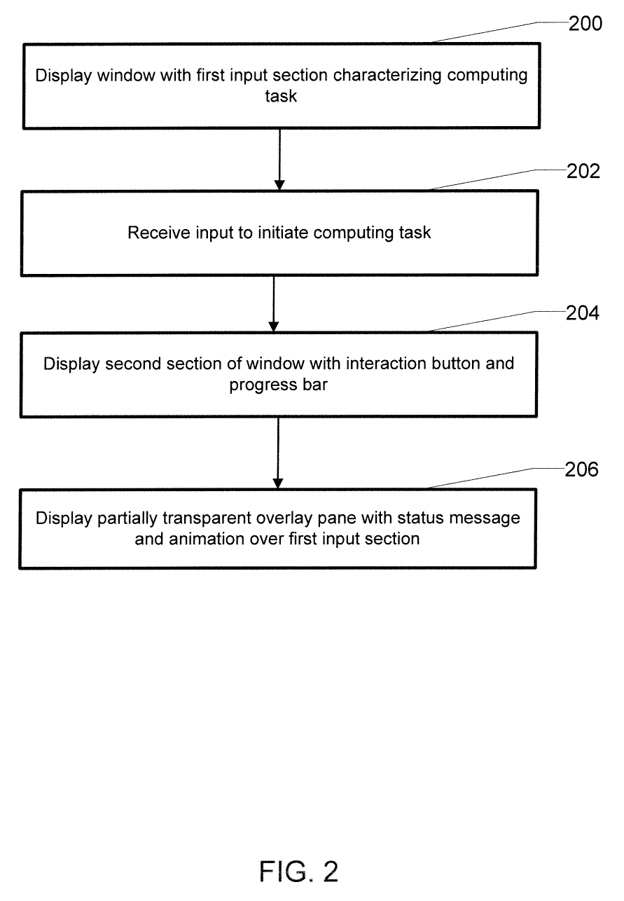

FIG. 2 illustrates a series of processing operations that may be implemented by the computer 100. The processing operations of FIG. 2 may be implemented using GUI module 114. The first operation of FIG. 2 is to display a window with a first input section characterizing a computing task 200. In one embodiment, the first input section includes a message describing a computing task so that a user may decide whether to initiate the computing task. The first input section may also include display of options for a user to select relating to the computing task, such as a list of data or documents to include for an importing or exporting task, or selectable program components to install for an installation task.

The next operation of FIG. 2 is to receive an input to initiate the computing task 202. In one embodiment, the input to initiate the computing task is generated by a user, such as by selecting a button in the first input section of the window displayed in operation 200. Alternatively, the input to initiate the computing task may be generated automatically, such as by another program module, like the BI module 120 for example.

The next operation of FIG. 2 is to display a second section of the window with an interaction button and a progress bar 204. The second section of the window may optionally replace or overlap a portion of the first section of the window. In one embodiment of the invention, the progress bar characterizes the progress of the computing task, such as by visually displaying an indicator extending over a portion of the progress bar corresponding to the portion of the computing task that has been completed. The interaction button allows a user to interact with the computing task while it is in progress. Examples of interaction buttons include a cancel button for cancelling the computing task, a pause button for pausing the computing task, and an information button for displaying additional information about the computing task.

The next operation of FIG. 2 is to display a partially transparent overlay pane including a status message and an animation over the first input section of the window 206. In one embodiment, the overlay pane covers at least a portion of the first input section of the window, such that the covered portion of the first input section is visible through the partially transparent overlay pane. In this embodiment, the animation on the overlay pane indicates that the computing task is active. An example of a suitable animation incorporates a varying pattern with one or more of: a moving wave, a moving radial portion of a circle, a moving image representing a document, an element of changing color or pattern, and an element of changing size or appearance, where the variation of the pattern indicates that the computing task is active and unstalled. An example of a suitable status message includes a message informing a user as to the nature of the computing task, or a sub-step of the task, such as “Importing, please wait” in the case of a computing task for importing data or documents.

In one embodiment, the covered portion of the first section of the window is updated while completing the computing task, or a sub-step of the task. In an example directed to a data importing computer task where the covered portion of the first section of the window displays a list of data to be imported, the appearance of the items in the data list may be updated while completing the data importing task. In another example, the covered portion of the first section of the window is updated relative to the progress of the computing task. For instance, the covered portion of the first section of the window may be updated to display a checkmark or other icon next to each item in the data list as that item is successfully imported while completing the data importing task.

In another embodiment, the window including one or more of the first and second sections, and the overlay pane may be hidden or covered in the GUI in order to display another window to initiate or conduct another computing task. Alternatively, multiple windows according to embodiments of the invention described above may be displayed simultaneously to display progress information relating to multiple computing tasks.

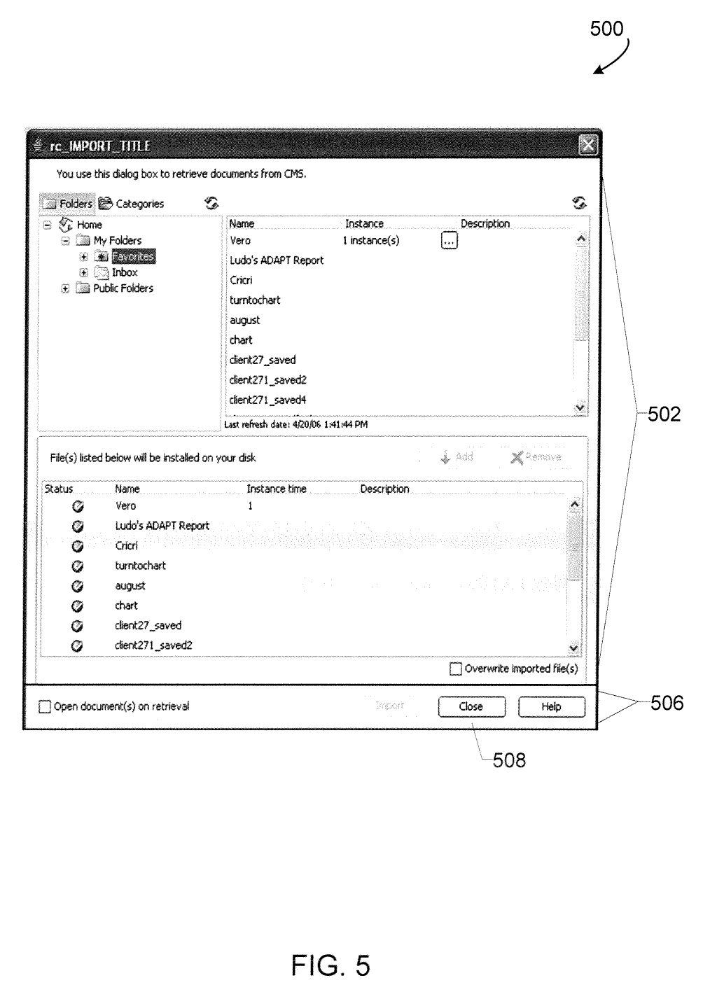

In one embodiment, upon completion of the computing task the overlay pane is removed, as shown in FIG. 5 and described below. The second section of the window may also be updated to reflect the completion of the task

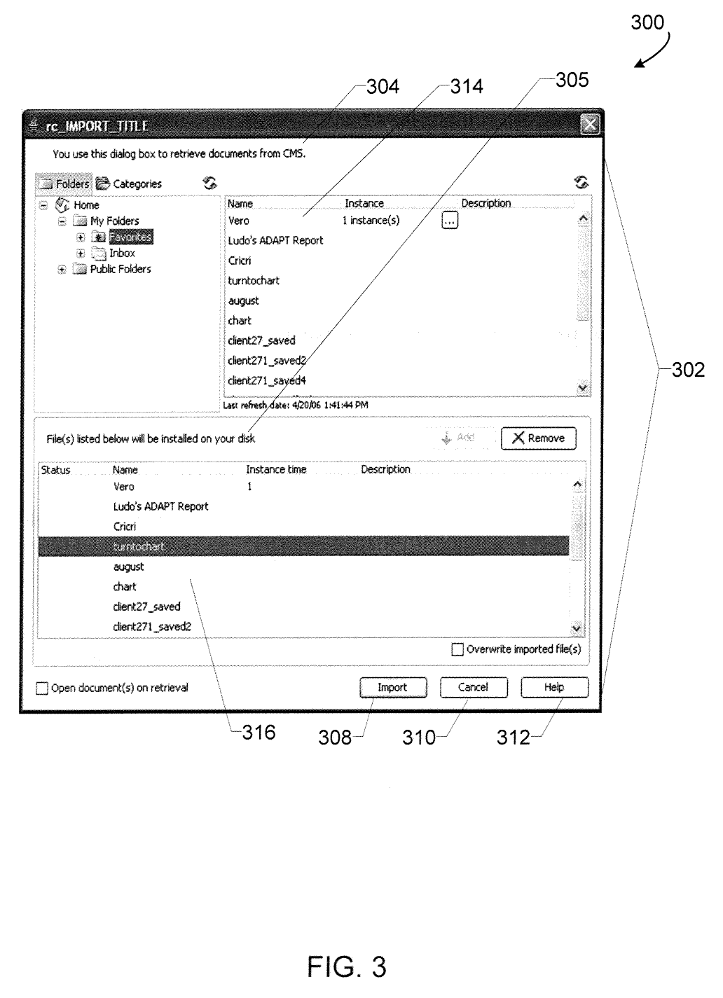

FIG. 3 illustrates a window 300 with a first section 302 characterizing a computing task, in accordance with an embodiment of the invention. The first section 302 includes message 304 which describes the purpose of a computing task, which in the illustrated embodiment is an exemplary document importation computing task. The first section 302 also includes a second message 305 describing the actions associated with the computing task, and interaction buttons 308, 310 and 312 for initiating, canceling and displaying information about the computing task, respectively.

The first section 302 of window 300 further includes user-selectable options relating to the computing task, including selectable document list 314, and confirmed document list 316, which display documents available and selected for importation, respectively.

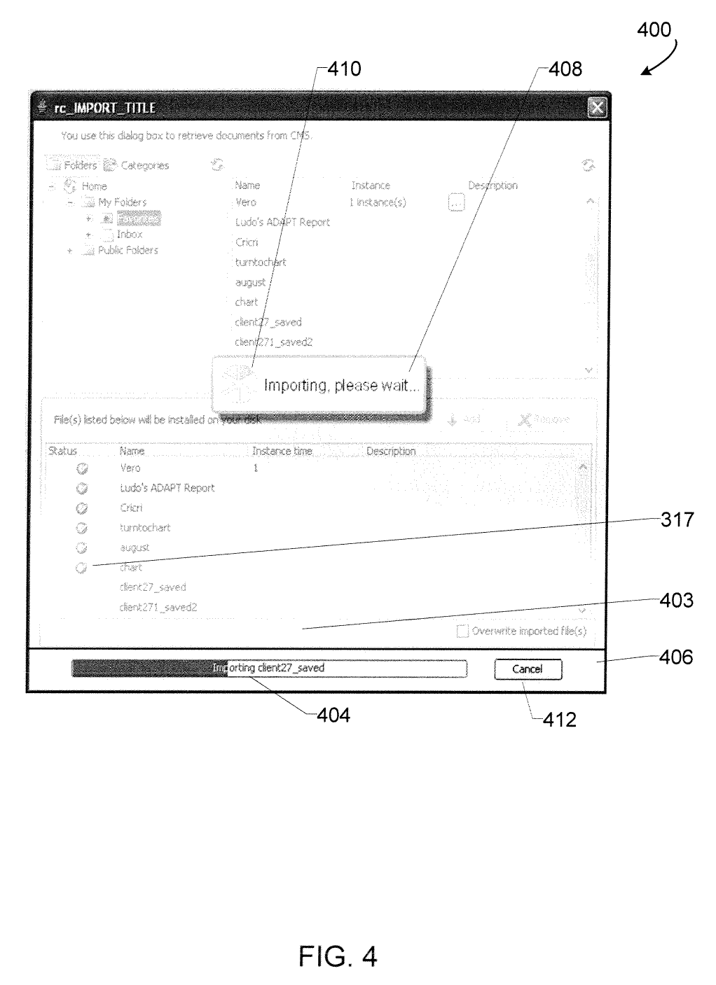

FIG. 4 illustrates a window 400 with first and second sections characterizing and displaying progress of a computing task in accordance with an embodiment of the invention. The first section of window 400 is covered by partially transparent overlay pane 403. The second section 406 of window 400 includes an interaction button such as cancel button 412 and progress bar 404, which characterizes the progress of the computing task Partially transparent overlay pane 403 includes status message 408 relating to the status of the computing task, and animation 410 indicating that the computing task is active by the movement of a radial portion of a circle.

Checkmark icon 317 is displayed on the first section of window 400, which is covered by overlay pane 403, but can be seen through the partially transparent overlay pane 403. Checkmark icon 317 updates the covered first section of window 400 relative to the progress of the computing task.

FIG. 5 illustrates a window 500 with first and second sections 502 and 506, characterizing and displaying the status of a completed computing task, in accordance with an embodiment of the invention. The overlay pane 403 displayed covering the first section of the window in FIG. 4 has been removed from window 500 upon completion of the computing task. The second section 506 of window 500 has been updated to reflect the completion of the computing task, including the removal of the progress bar shown in FIG. 4 while the computing task was in progress, and the addition of the “Close” interaction button 508.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
displaying a window with a first section characterizing a computing task and a second section with a progress bar and an interaction button; and
displaying an overlay pane with a status message and an animation indicating that the computing task is active, wherein the overlay pane covers at least a portion of the first section, and is partially transparent such that a covered portion of the first section is visible through the overlay pane.

2. The computer implemented method according to claim 1, wherein displaying a window with a first section characterizing a computing task further comprises receiving an input to initiate the computing task.

3. The computer implemented method according to claim 1, wherein the progress bar characterizes the progress of the computing task.

4. The computer implemented method according to claim 1, wherein the second section replaces a portion of the first section.

5. The computer implemented method according to claim 1, further comprising updating the covered portion of the first section while completing the computing task.

6. The computer implemented method according to claim 5, wherein the covered portion of the first input section is updated relative to the progress of the computing task.

7. The computer implemented method according to claim 1, wherein the window is a first window and the computing task is a first computing task further comprising displaying a second window related to a second computing task, while the first computing task is in progress.

8. The computer implemented method according to claim 1, further comprising removing the overlay pane and updating the second section of the window upon completion of the computing task.

9. The computer implemented method according to claim 1, wherein the interaction button is selected from a cancel button, a pause button, and an information button for displaying additional information about the computing task.

10. The computer implemented method according to claim 1, wherein the animation comprises a varying pattern with one or more of: a moving wave, a moving radial portion of a circle, a moving image representing a document, an element of changing color or pattern, and an element of changing size or appearance, wherein a variation of the pattern indicates that the computing task is active.

11. A computer readable storage medium storing executable instructions to display the status of a computing task, comprising executable instructions to:
display a window with a first section characterizing a computing task and a second section with a progress bar and an interaction button; and
display an overlay pane with a status message and an animation indicating that the computing task is active, wherein the overlay pane covers at least a portion of the first section, and is partially transparent such that a covered portion of the first section is visible through the overlay pane.

12. The computer readable storage medium according to claim 11, wherein the executable instructions to display a window with a first section characterizing a computing task further comprise executable instructions to receive an input to initiate the computing task.

13. The computer readable storage medium according to claim 1 wherein the progress bar characterizes the progress of the computing task.

14. The computer readable storage medium according to claim 11, wherein the second section replaces a portion of the first section.

15. The computer readable storage medium according to claim 11, further comprising executable instructions to update the covered portion of the first section while completing the computing task.

16. The computer readable storage medium according to claim 15 wherein the covered portion of the first section is updated relative to the progress of the computing task.

17. The computer readable storage medium according to claim 11, wherein the window is a first window and the computing task is a first computing task, further comprising executable instructions to display a second window related to a second computing task, while the first computing task is in progress.

18. The computer readable storage medium according to claim 11, further comprising executable instructions to remove the overlay pane and update the second section of the window upon completion of the computing task

19. The computer readable storage medium according to claim 11, wherein the interaction button is selected from a cancel button, a pause button, and an information button for displaying additional information about the computing task.

20. The computer readable storage medium according to claim 11, wherein the animation comprises a varying pattern with one or more of: a moving wave, a moving radial portion of a circle, a moving image representing a document, an element of changing color or pattern, and an element of changing size or appearance, wherein a variation of the pattern indicates that the computing task is active.
